(19) United States
(12) Patent Application Publication
(10) Pub. No.: US 2026/0356402 A1
(43) Pub. Date: Nov. 12, 2026

(54) MOBILE ON-DUTY ASSISTANCE APPARATUS AND METHOD FOR FULLY-AUTOMATIC UNMANNED TRAINS

(71) Applicant: CASCO SIGNAL LTD., Shanghai (CN)

(72) Inventors: Jiafu PEI, Shanghai (CN); Bingjian ZHANG, Shanghai (CN); Enhua HU, Shanghai (CN); Liangqiang BAO, Shanghai (CN); Haitao XI, Shanghai (CN); Bingfeng ZHANG, Shanghai (CN); Changfeng YANG, Shanghai (CN); Li LIN, Shanghai (CN)

(73) Assignee: CASCO SIGNAL LTD., Shanghai (CN)

(21) Appl. No.: 19/125,291

(22) PCT Filed: Nov. 20, 2023
(86) PCT No.: PCT/CN2023/132490

§ 371 Date: Apr. 28, 2025

(30) Foreign Application Priority Data
Dec. 28, 2022 (CN) 202211695031.4

(51) Int. Cl. B61L 27/04; B61L 27/40; B61L 27/57

(52) U.S. Cl. CPC B61L 27/04; B61L 27/40; B61L 27/57

(57) ABSTRACT

A mobile on-duty assistance apparatus for a fully-automatic unmanned trains. The apparatus comprises: a train data collection unit, which accesses data of a fully-automatic operating vehicle train, and trackside key operation information (SI); a vehicle train data processing unit, which is used for performing unified processing on collected data, writing the data into a real-time database, and generating a fault alarm according to state information (S2); a train data analysis unit, which is used for performing fused analysis on the collected and processed data, and performing positioning, cause analysis and influence analysis on a complex fault (S3); a portable on-duty unit, which is used for acquiring, in real time, a key fault and operation information related to the present train, allowing an on-duty person to quickly and actively acquire operation information of the fully-automatic train, and providing related troubleshooting guidance; and an LTE communication unit.

### TECHNICAL FIELD

The present invention relates to a train signal control system and, in particular, to a mobile on-duty assistance apparatus and method for fully automatic unmanned trains.

### DESCRIPTION OF RELATED ART

In recent years, fully automatic unmanned driving projects in urban rail transit have developed vigorously, and more and more lines adopt fully automatic unmanned driving construction and operation patterns. Since fully automatic unmanned trains are no longer equipped with drivers, the driver's responsibilities transfer to dispatchers of the Operation Control Center (OCC). The metro operating company has set up special dispatcher in OCC to be responsible for the supervision and emergency handling of fully automatic trains throughout the line. In order to provide better passengers service and handle faults quickly in case of faults or emergency situations, trains of fully automatic unmanned driving line may also be equipped with on-duty personnel, who are mainly responsible for emergency handling of train faults and passenger services, manually driving trains in special scenarios, and so on.

However, at present, the on-duty personnel for trains lack the technical support means to actively obtain real-time supervision of fully automatic trains, passenger service facilities and requests, and they also lack the technical support means to efficiently troubleshoot accidents in case of faults. The on-duty personnel on trains can only passively obtain fully automatic train faults and passenger requirement information by wireless intercom devices, and passively receive commands from dispatchers in the OCC. In this working mode, the efficiency of on-duty personnel for troubleshooting and passenger services is relatively low, which is not conducive to the safe and reliable operation of fully automatic unmanned trains. Moreover, the on-duty personnel can't actively obtain key operational events in train operating sections, such as section flooding, station fires, and large passenger flow, which is not conducive to efficient coordination with dispatchers, station services and other personnel to deal with faults.

### SUMMARY OF THE INVENTION

An objective of the present invention is to provide a mobile on-duty assistance apparatus and method for fully automatic unmanned trains, in order to overcome the above shortcomings in the prior art.

The objective of the present invention may be achieved by the following technical solution:

According to a first aspect of the present invention, provided is a mobile on-duty assistance apparatus for fully automatic unmanned trains, including:
a train data collection unit configured to collect fully automatic operating train data and key wayside operation information by means of a network isolation device;
a train data processing unit connected with the train data collection unit and configured to homogenize collected data and write the homogenized data into a real-time database and to generate fault alarms according to status information;
a train data analysis unit configured for fusion analysis of the collected and processed data and for positioning, cause analysis and impact analysis of a complex fault;
a portable on-duty unit configured to obtain key fault and operation information related to the train in real time, allowing on-duty personnel to obtain fully automatic train operation information quickly and actively and provide relevant troubleshooting guidance;
an LTE communication unit configured to communicate with the portable on-duty unit via LTE network and push the key fault and operation information of the train and stations to the portable on-duty unit.

As a preferred technical solution, the fully automatic operating train data includes operation and fault data of traction system, auxiliary system, braking system, pyrotechnic system, and air conditioning system.

As a preferred technical solution, the key wayside operation information includes section flooding, section fires, station fires, people trapped at station platform doors, and large passenger flow at stations.

As a preferred technical solution, the portable on-duty unit sends reset control instructions in case of faults.

As a preferred technical solution, the LTE network is an integrated bearer network for rail transit.

As a preferred technical solution, the portable on-duty unit includes private LTE network communication module, graphical display module, real-time alarm management module, troubleshooting guidance module and remote control module;
the private LTE network communication module is respectively connected with the graphical display module, the real-time alarm management module and the remote control module, and the troubleshooting guidance module is connected with the real-time alarm management module.

As a preferred technical solution, the private LTE network communication module is configured to be connected to LTE integrated bearer network for rail transit and to communicate with wayside equipment, and obtain key train/wayside fault and operation information.

As a preferred technical solution, the graphical display module is responsible for subscribing real-time train status data from wayside equipment and displaying the real-time train status data to the on-duty personnel in a graphical manner.

As a preferred technical solution, the real-time alarm management module is responsible for alerting the on-duty personnel in case of serious alarms generated by voice and providing fault details.

As a preferred technical solution, the real-time alarm management module determines whether to display the alarms according to the role of the currently logged-in user.

As a preferred technical solution, the troubleshooting guidance module provides troubleshooting guidance to the on-duty personnel in the form of videos, pdf files or pictures, and also provides a visual and operable emergency handling plan to assist the on-duty personnel efficiently and correctly handling the fault.

As a preferred technical solution, the remote control module sends control instructions to the train under special circumstances to control train switching and fault reset; the remote control module allows the control instructions to be issued only when the train is in a stationary state.

According to a second aspect of the present invention, provided is a method for the mobile on-duty assistance apparatus for fully automatic unmanned trains. The method includes the following steps:
step S1, obtaining real-time fully automatic train operation and fault data of trains from TCMS and ATS by the train data collection unit in real time via specialized protocol, and synchronizing the data to the train data processing unit;
step S2, homogenizing the received heterogeneous data by the train data processing unit, and writing the homogenized data into a real-time database for subscription by a portable on-duty terminal; and also generating fault alarms according to rules and pushing the fault alarms to the LTE communication unit;
step S3, performing fault fusion analysis by the train data analysis unit in combination with multi-professional data, locating specific fault location and providing fault cause analysis and fault impact range;
step S4, pushing the alarms generated in step S2 to the portable on-duty unit by the LTE communication unit;
step S5, obtaining alarm information from the LTE communication unit by the portable on-duty unit in real time, and determining whether to display the alarm information on the on-duty unit according to the role of the logged-in user; if yes, firstly alerting to the on-duty personnel of serious alarms occurring in the train by voice and displaying the alarms in the real-time alarm column;
step S6: obtaining the troubleshooting guidance related to the fault from the train data processing unit via the LTE communication unit according to the fault information by the portable on-duty unit.

As a preferred technical solution, the step of pushing the alarms in step S2 is implemented by:
step S21, based on the real-time location of the train sent by ATS, calculating in real time the section and station range where the train is located and whether the train stops at platform;
step S22, when the train data processing unit generates alarms, checking the number of the train which is running in the station section or stopped at the platform, and filling the number of the train to the zone priority field Zone_Level;
step S23, when the portable on-duty unit receives the alarms, checking whether the Zone_Level includes the train; if yes, displaying the alarms on the device and alerting the on-duty personnel by voice.

As a preferred technical solution, step S3 is specifically implemented by:
step S31, establishing fault analysis model based on multi-branch tree, and associating the fault with possible trigger causes by the multi-branch tree;
step S32, loading the multi-branch tree model on the train data analysis unit, subscribing fault data from the real-time database and performing supervision in real time, and when analysis conditions are met, traversing the multi-branch tree to locate the fault location and cause;
step S33, analyzing, by the train data analysis unit according to the fault location and cause, whether the fault can be restored by the remote control or reset command;
step S34, analyzing, by the train data analysis unit, the possible impact range of the fault according to the fault location, cause and train operating section, and providing decision-making suggestions whether the train needs to be offline or continue to operate;
step S35, synchronously pushing an analysis result to the portable on-duty unit by the LTE communication unit to guide the on-duty personnel to handle the fault.

According to a third aspect of the present invention, provided is an electronic device, including a memory and a processor. A computer program is stored in the memory, and the processor implements the method when executing the program.

According to a fourth aspect of the present invention, provided is a computer-readable storage medium having stored there on a computer program. The program implements the method when executed by a processor.

Compared with the cited reference, the present invention has the following advantages:
1. The present invention designs a portable on-duty unit by which fully automatic train on-duty personnel can actively obtain fully automatic operating train faults and passenger dynamics in real time.
2. The present invention provides visual troubleshooting guidance for the fully automatic train on-duty personnel, and can guide on-duty assistance personnel to efficiently and correctly handle faults.
3. The present invention designs a dynamic train zone analysis function, which can synchronize serious faults or events related to wayside with the fully automatic train on-duty personnel. This is conducive to multi-position collaborative handling and ensures operation reliability.

### BRIEF DESCRIPTION OF THE DRAWINGS

FIG. 1 is a schematic structural diagram of the mobile on-duty assistance apparatus for fully automatic unmanned trains according to the present invention.

FIG. 2 is a schematic structural diagram of the portable on-duty unit according to the present invention.

FIG. 3 is a flow chart of a mobile on-duty assistance method for fully automatic unmanned trains according to the present invention.

FIG. 4 is a schematic diagram of a calculation logic of alarm distribution of wayside station according to the present invention.

FIG. 5 is a schematic diagram of an analysis solution of the train data analysis unit according to the present invention.

### DETAILED DESCRIPTION OF THE EMBODIMENTS

The technical solutions in the embodiments of the invention will be clearly and completely described below in combination with the accompanying drawings in the embodiments of the invention. Obviously, the described embodiments are only some, not all of the embodiments of the invention. Based on the embodiments of the invention, all other embodiments obtained by those of ordinary skill in the art without creative work fall within the scope of the invention.

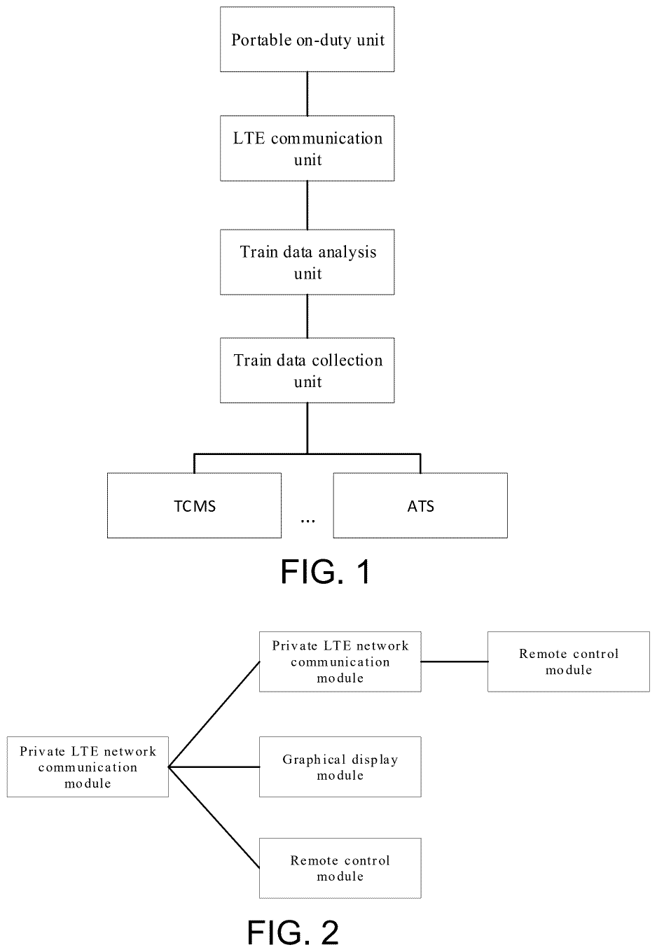

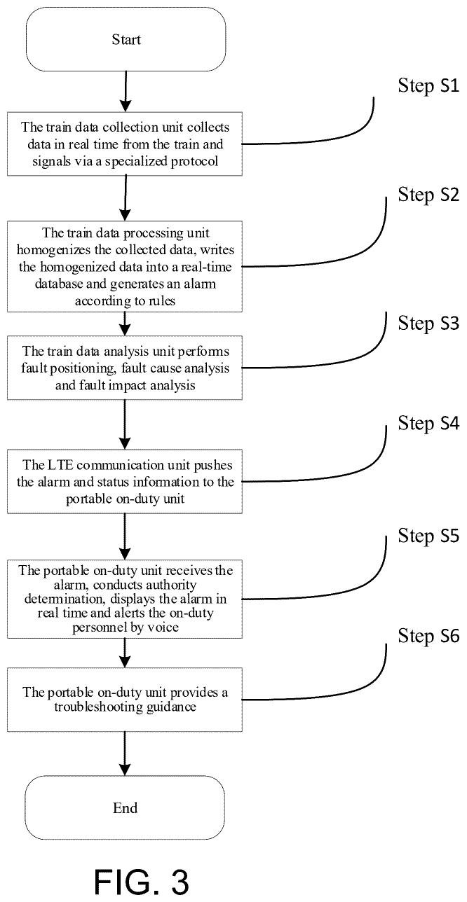

As shown in FIG. 1, the present invention describes a mobile on-duty assistance apparatus for fully automatic unmanned trains, including the following steps:
step S₁, obtaining real-time fully automatic train operation and fault data from professional systems of the train, such as TCMS and signal ATS, by the train data collection unit in real time via specialized protocol, the train data collection unit being responsible for real-time analysis, and synchronizing the data to the train data processing unit;
step S₂, homogenizing, by the train data processing unit, received heterogeneous data and writing the homogenized data into a real-time database for subscription by the portable on-duty terminal; and also generating fault alarms according to rules and pushing the fault alarms to the LTE communication unit;
step S₃, performing fault fusion analysis by the train data analysis unit in combination with multi-professional data, locating specific fault and providing fault cause analysis and fault impact range;
step S₄, pushing, by the LTE communication unit, the alarms generated in step S2 to the portable on-duty unit;
step S₅, obtaining alarm information from the LTE communication unit by the portable on-duty unit in real time, and determining whether to display the alarm information on the on-duty unit according to the role of the logged-in user; if yes, firstly alerting the on-duty personnel of serious alarms occurring in the train by voice and displaying the alarm in a real-time alarm column;
step S₆: obtaining, by the portable on-duty unit, a troubleshooting guidance related to the fault from the train data processing unit via the LTE communication unit according to the fault information. The troubleshooting guidance include videos, pdf files or pictures.

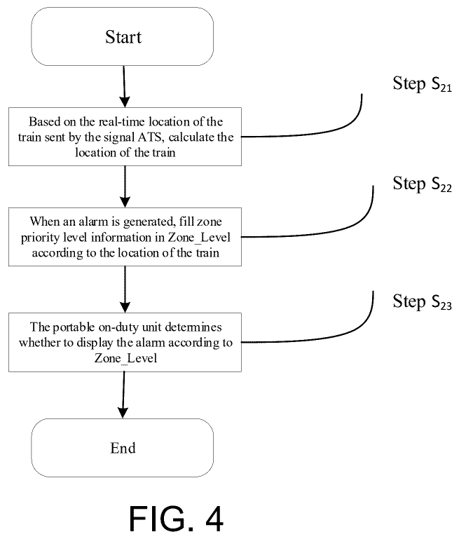

As shown in FIG. 4, the solution for pushing the alarms in step S2 is illustrated as including the following steps:
step S2₁, based on the real-time location of the train sent by the ATS, calculating in real time section and station range where the train is located and whether the train stops at a platform;
step S2₂, when the train data processing unit generates alarms, checking the number of the train running in the station section or stopped at the platform, and filling the number of the train in the zone priority field Zone_Level; and
step S2₃, when the portable on-duty unit receives the alarms, checking whether the Zone_Level includes the train; if yes, displaying the alarms on the device and alerting the on-duty personnel by voice.

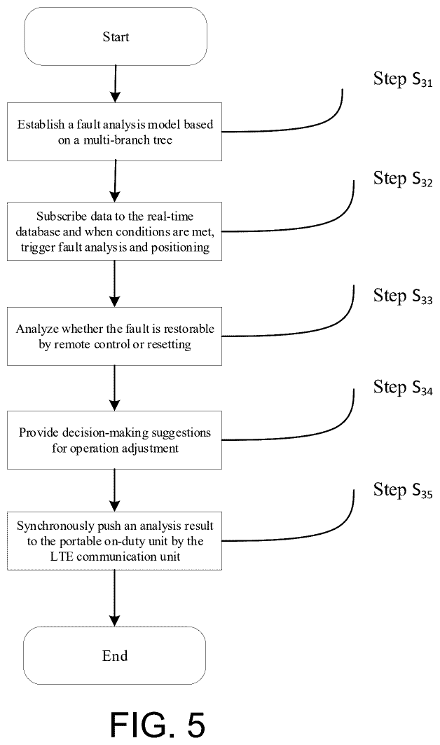

As shown in FIG. 5, the solution for fault analysis is illustrated as including the following steps:
step S3₁, establishing a fault analysis model based on a multi-branch tree, and associating the fault with possible trigger causes by the multi-branch tree;
step S3₂, loading the multi-branch tree model on the train data analysis unit, subscribing fault data to the real-time database and performing supervision in real time, and when analysis conditions are met, traversing the multi-branch tree to locate the fault location and cause;
step S3₃, analyzing, by the train data analysis unit according to the fault location and cause, whether the fault is restored by a remote control or reset device;
step S3₄, analyzing, by the train data analysis unit, the possible impact range of the fault according to the fault location and cause and the train operating section, and providing decision-making suggestions on whether the train needs to be offline or continue to operate;
step S3₅, synchronously pushing an analysis result to the portable on-duty unit by the LTE communication unit to guide the on-duty personnel to handle the fault.

The above is description of method embodiments, and the following is an apparatus embodiment to further describe the solution of the present invention.

As shown in FIG. 1, the overall structure of the apparatus according to the present invention is illustrated. The mobile on-duty assistance apparatus for fully automatic unmanned trains according to the present invention includes a train data collection unit, a train data processing unit, a train data analysis unit, an LTE communication unit, and a portable on-duty unit.

The train data collection unit is configured to collect fully automatic operating train data and key wayside operation information by means of a network isolation device. The fully automatic operating train data includes key operation and fault data of traction system, auxiliary system, braking system, pyrotechnic system, air conditioning system and so on. The key wayside operation information includes information about section flooding, section fires, station fires, people trapped at station platform doors, large passenger flow at stations, etc.

The train data processing unit is configured to homogenize collected data and write the homogenized data into a real-time database and to generate fault alarms according to status information.

The train data analysis unit is configured for fusion analysis of the collected and processed data and for positioning, cause analysis and impact analysis of complex fault.

The LTE communication unit is responsible for communicating with the portable on-duty unit via LTE network and pushing the key fault and operation information of the train and stations to the portable on-duty unit. The LTE network is an integrated bearer network for rail transit.

The portable on-duty unit is carried by the on-duty personnel and may be connected to the private LTE network for rail transit. The portable on-duty unit may obtain key fault and operation information related to the train in real time by the LTE network, allowing the on-duty personnel to quickly and actively obtain fully automatic train operation information and provide relevant troubleshooting guidance. The portable on-duty unit may also send train fault reset control instructions in case of the fault.

As shown in FIG. 2, the overall structure of the portable on-duty unit according to the present invention is described as including the following contents:

The portable on-duty unit mainly includes a private LTE network communication module, a graphical display module, an alarm management module, a troubleshooting guidance module, a voice alarm module and a remote control module.

The private LTE network communication module is configured to be connected to an LTE integrated bearer network for rail transit, communicate with wayside equipment, and obtain key train/wayside fault and operation information.

The graphical display module is responsible for subscribing real-time train status data to wayside equipment and displaying the real-time train status data to the on-duty personnel in a graphical manner.

The alarm management module is responsible for alerting the on-duty personnel of serious alarms by voice and providing fault details. The alarm management module may determine whether to display the alarms to a currently logged-in user according to the role of the currently logged-in user.

The troubleshooting guidance module provides the troubleshooting guidance to the on-duty personnel in the form of videos, pdf files or pictures, and also provides a visual and operable emergency handling plan to assist the on-duty personnel in efficiently and correctly handling the fault.

The remote control module sends control instructions to the train under special circumstances to control train switching and fault reset. The remote control module allows the control instructions to be issued only when the train is in a stationary state.

Those skilled in the art could clearly understand that for convenience and brevity of description, the specific working process of the described modules may be referred to the corresponding processes in the foregoing method embodiments, and will not be repeated here.

The electronic device of the present invention includes a central processing unit (CPU) that perform various appropriate actions and processes in accordance with computer program instructions stored in a read-only memory (ROM) or computer program instructions loaded from a storage unit into a random access memory (RAM). The RAM may further store various programs and data required for the operation of the device. The CPU, the ROM, and the RAM are connected to each other by a bus. An input/output (I/O) interface is also connected to the bus.

Multiple components in the device are connected to the I/O interface and include: an input unit, such as a keyboard and a mouse; an output unit, such as various types of displays and speakers; a storage unit, such as a magnetic disk and an optical disk; and a communication unit, such as a network card, a modem, and a wireless communication transceiver. The communication unit allows the device to exchange information/data with other devices over a computer network such as the Internet and/or various telecommunications networks.

The processing unit performs various methods and processing described above, such as the method of S1 to S6. For example, in some embodiments, the method of S1 to S6 may be implemented as a computer software program, which is tangibly contained in a machine-readable medium, such as the storage unit. In some embodiments, the computer program may be, in part or completely, loaded and/or installed onto the device via the ROM and/or the communication unit. When the computer program is loaded onto the RAM and executed by the CPU, one or more steps of the method of S1 to S6 described above may be performed. Alternatively, in other embodiments, the CPU may be configured, by any other suitable means (e.g., by means of firmware), to execute the method of S1 to S6.

The functions described above herein may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system on chip (SOC), complex programmable logic devices (CPLDs).

Program codes for implementing the method of the present invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program codes may be executed entirely on the machine, partially on the machine, partially on the machine as a stand-alone software package and partially on a remote machine or entirely on a remote machine or server.

In the context of the present invention, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above are only specific embodiments of the invention, but the scope of the invention is not limited thereto. Any person skilled in the art could easily think of various equivalent modifications or substitutions within the technical scope disclosed herein. These modifications or substitutions should fall within the scope of the invention. Therefore, the scope of the present invention should be based on the scope of the claims.

1. A mobile on-duty assistance apparatus for fully automatic unmanned trains, comprising:
a train data collection unit configured to collect fully automatic operating train data and key wayside operation information by means of a network isolation device;
a train data processing unit connected with the train data collection unit and configured to homogenize collected data and write homogenized data into real-time database and to generate fault alarms according to status information;
a train data analysis unit configured for fusion analysis of collected and processed data and for positioning, cause analysis and impact analysis of complex fault;
a portable on-duty unit configured to obtain key fault and operation information related to train in real time, allowing on-duty personnel to quickly and actively obtain fully automatic train operation information and provide relevant troubleshooting guidance;
an LTE communication unit configured to communicate with the portable on-duty unit via an LTE network and push the key fault and the operation information of the train and stations to the portable on-duty unit.

2. The mobile on-duty assistance apparatus for the fully automatic unmanned trains according to claim 1, wherein the fully automatic operating train data comprises operation and fault data of traction system, auxiliary system, braking system, pyrotechnic system, and air conditioning system.

3. The mobile on-duty assistance apparatus for the fully automatic unmanned trains according to claim 1, wherein the key wayside operation information comprises information about section flooding, section fires, station fires, people trapped at station platform doors, and large passenger flow at stations.

4. The mobile on-duty assistance apparatus for the fully automatic unmanned trains according to claim 1, wherein the portable on-duty unit send train fault reset control instructions in case of fault.

5. The mobile on-duty assistance apparatus for the fully automatic unmanned trains according to claim 1, wherein the LTE network is an integrated bearer network for rail transit.

6. The mobile on-duty assistance apparatus for the fully automatic unmanned trains according to claim 1, wherein the portable on-duty unit comprises a private LTE network communication module, a graphical display module, a real-time alarm management module, a troubleshooting guidance module and a remote control module;
the private LTE network communication module is respectively connected with the graphical display module, the real-time alarm management module and the remote control module, and the troubleshooting guidance module is connected with the real-time alarm management module.

7. The mobile on-duty assistance apparatus for the fully automatic unmanned trains according to claim 6, wherein the private LTE network communication module is configured to be connected to LTE integrated bearer network for rail transit, communicate with wayside equipment, and obtain key train/wayside fault and operation information.

8. The mobile on-duty assistance apparatus for the fully automatic unmanned trains according to claim 6, wherein the graphical display module is responsible for subscribing real-time train status data to wayside equipment and displaying the real-time train status data to the on-duty personnel in a graphical manner.

9. The mobile on-duty assistance apparatus for the fully automatic unmanned trains according to claim 6, wherein the real-time alarm management module is responsible for alerting the on-duty personnel of serious alarms by voice and providing fault details.

10. The mobile on-duty assistance apparatus for the fully automatic unmanned trains according to claim 6, wherein the real-time alarm management module determines whether to display alarms to currently logged-in user according to role of the currently logged-in user.

11. The mobile on-duty assistance apparatus for the fully automatic unmanned trains according to claim 6, wherein the troubleshooting guidance module provides troubleshooting guidance to the on-duty personnel in the form of videos, pdf files or pictures, and also provides visual and operable emergency handling plan to assist the on-duty personnel in efficiently and correctly handling the fault.

12. The mobile on-duty assistance apparatus for the fully automatic unmanned trains according to claim 6, wherein the remote control module sends control instructions to train under special circumstances to control train switching and fault reset; the remote control module allows the control instructions to be issued only when the train is in a stationary state.

13. A method for the mobile on-duty assistance apparatus for fully automatic unmanned trains according to claim 1, wherein the method comprises the following steps:
step S1, obtaining real-time fully automatic train operation and fault data from TCMS and signal ATS of train by train data collection unit in real time via specialized protocol, the train data collection unit being responsible for real-time analysis, and synchronizing the data to a train data processing unit;
step S2, homogenizing, by the train data processing unit, received heterogeneous data and writing homogenized data into real-time database for subscription by portable on-duty terminal; and also generating fault alarms according to rules and pushing the fault alarms to LTE communication unit;
step S3, performing fault fusion analysis by train data analysis unit in combination with multi-professional data, locating specific fault location and providing fault cause analysis and fault impact range;
step S4, pushing, by the LTE communication unit, alarms generated in step S2 to portable on-duty unit;
step S5, obtaining alarm information from the LTE communication unit by the portable on-duty unit in real time, and determining whether to display the alarm information on the on-duty unit according to role of logged-in user; if yes, firstly alerting the on-duty personnel of serious alarms occurring in the train by voice and displaying alarms in a real-time alarm column;
step S6: obtaining, by the portable on-duty unit, troubleshooting guidance related to the fault from the train data processing unit via the LTE communication unit according to the fault information.

14. The method according to claim 13, wherein step of pushing the alarms in the step S2 is implemented by:
step S21, based on real-time location of the train sent by ATS, calculating in real time section and station range where the train is located and whether the train stops at platform;
step S22, when the train data processing unit generates alarms, checking number of the train running in station section or stopped at the platform, and filling the number of the train in zone priority field Zone_Level;
step S23, when the portable on-duty unit receives the alarms, checking whether the Zone_Level includes the train; if yes, displaying the alarms on the device and alerting the on-duty personnel by voice.

15. The method according to claim 13, wherein the step S3 is specifically implemented by:
step S31, establishing a fault analysis model based on multi-branch tree, and associating the fault with possible trigger causes by the multi-branch tree;
step S32, loading the multi-branch tree model on the train data analysis unit, subscribing fault data to the real-time database and performing supervision in real time, and when analysis conditions are met, traversing the multi-branch tree to locate the fault location and cause;
step S33, analyzing, by the train data analysis unit according to the fault location and cause, whether the fault is restored by remote control or reset device;
step S34, analyzing, by the train data analysis unit, possible impact range of the fault according to the fault location and cause and the train operating section, and providing decision-making suggestions on whether the train needs to be offline or continue to operate;
step S35, synchronously pushing an analysis result to the portable on-duty unit by the LTE communication unit to guide the on-duty personnel to handle the fault.

16. An electronic device, comprising a memory and a processor, a computer program being stored in the memory, that, wherein the processor implements the method according to claim 13 when executing the program.

17. A computer-readable storage medium, having stored thereon a computer program, wherein the program implements the method according to claim 13 when executed by a processor.

18. An electronic device, comprising a memory and a processor, a computer program being stored in the memory, wherein the processor implements the method according to claim 14 when executing the program.

19. An electronic device, comprising a memory and a processor, a computer program being stored in the memory, wherein the processor implements the method according to claim 15 when executing the program.

20. A computer-readable storage medium, having stored thereon a computer program, wherein the program implements the method according to claim 14 when executed by a processor.
